(19) United States
(12) Patent Application Publication
(10) Pub. No.: US 2009/0100679 A1
(43) Pub. Date: Apr. 23, 2009

(54) SHAVING APPARATUS AND METHODS

(75) Inventors: Gregory D. Casciaro, San Mateo, CA (US); John M. Casciaro, Huntley, IL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Greg'jon LLC, Minden, NV (US)

(21) Appl. No.: 12/248,842

(22) Filed: Oct. 9, 2008

Related U.S. Application Data
(60) Provisional application No. 60/981,031, filed on Oct. 18, 2007.

(51) Int. Cl. B26B 21/00; B26B 21/52

(52) U.S. Cl. 30/34.05; 30/526

(57) ABSTRACT

A shaving device for shaving hard-to-reach areas of the body is provided. The device comprises a head; a blade mounted to the head and having an edge adapted for cutting hair; an elongated handle having a distal end coupled to the head and a proximal extremity adapted for being held in a user's hand, the elongated handle being resiliently deflectable about a transverse axis.

### CROSS-REFERENCES TO RELATED APPLICATIONS

This application is a non-provisional of and claims the benefit of priority of U.S. Provisional Patent Application No. 60/981,031 (Attorney Docket No. 027142-000100US) filed Oct. 18, 2007, the entire contents of which are incorporated herein by reference.

### BACKGROUND OF THE INVENTION

This invention relates generally to shaving devices, and more particularly to devices for shaving the back and other hard-to-reach areas of the body.

Some people suffer from excessive hair growth in hard-to-reach areas such as the legs and back. Accessing these areas in order to shave or trim such hair can be challenging. Particularly in older, physically limited, or injured people, shaving unwanted hair on the back or legs can be very difficult or impossible using conventional shaving devices. In addition, many conventional shaving devices have rigid handles and exposed blades which can cut the skin easily if not carefully controlled, making such devices unsuited for use in hard-to-reach areas where the blade may be difficult to control and observe while shaving.

### BRIEF SUMMARY OF THE INVENTION

The present invention provides a device for shaving hair in hard-to-reach areas of the body such as the back and legs.

In a first embodiment, a shaving device comprises a head; a blade mounted to the head and having an edge adapted for cutting hair; an elongated handle having a distal end coupled to the head and a proximal extremity adapted for being held in a user's hand, the elongated handle being resiliently deflectable about a transverse axis.

In preferred embodiments the handle is extendable from a retracted length to an extended length. The extended length of the handle is preferably at least 1.5 times the retracted length, and is usually at least about 8 inches in length, more preferably at least about 12 inches in length. In exemplary embodiments the handle has a telescoping construction, comprising a proximal member and a distal member, the distal member being longitudinally slidable relative to the proximal member. The handle may further include one or more intermediate members coupled between the proximal and distal members, the intermediate member(s) being longitudinally slidable relative to the proximal member and the distal member. Preferably, the distal and proximal members have a rectangular transverse cross-section, the width of the cross-section being at least twice the height, more preferably at least 3 times the height, in order to achieve optimal flexibility about a transverse axis and compact construction.

In some embodiments the head is flexible such that the blade is resiliently deflectable about a transverse axis relative to the handle. The head is preferably detachably coupled to the handle. Various types of detachable couplings are possible, but in one exemplary embodiment, the handle comprises a receptacle at the distal end and the head comprises a tongue removably positionable in the receptacle. The receptacle may further comprise a catch, and the tongue comprises at least one transverse ridge, the catch engaging the ridge to maintain the tongue in the receptacle. The blade of the device is preferably laterally offset from the longitudinal axis of the handle; i.e. a distal extremity of the handle defines a longitudinal axis, and the edge of the blade is transverse to and spaced apart from the longitudinal axis. This provides an optimal shaving angle of the blade relative to the skin and allows the blade to engage the skin during shaving without interference from the handle.

The head of the shaving device usually comprises a frame forming a transverse slot into which the edge of the blade extends. The frame may have a working surface, usually smooth and slippery, for engaging the skin. In preferred embodiments, the frame further comprises a plurality of teeth extending into the slot over the edge of the blade on an upper side thereof opposite the working surface. These teeth engage the skin as blade is slid across the surface of the skin, preventing the blade from cutting the skin.

The invention further provides a method of shaving hair from a region of the body comprising providing a shaving device having a handle, a head, and a blade attached to the head; detachably coupling the head to a distal end of the handle; extending the handle from a retracted length to an extended length; positioning a working surface of the head against a skin surface in the region of the body; applying pressure to a proximal end of the handle such that the head deflects about a transverse axis; and manipulating the handle so as to slide the blade across the skin surface in a direction transverse to the blade, thereby cutting the hair. Preferably, the head comprises a plurality of teeth extending over the blade on an upper side thereof opposite the working surface, and wherein the hair is channeled in between the teeth as the blade slides across the skin surface. The teeth may engage the skin as the blade slides across the skin surface to prevent the blade from cutting the skin. In a specific embodiment, the region of the body to be shaved is the back.

These and other embodiments are described in further detail in the following description related to the appended drawing figures.

### BRIEF DESCRIPTION OF THE DRAWINGS

FIG. 1 is a perspective view of a shaving device according to one exemplary embodiment the invention.

FIG. 2 is a bottom view of the shaving device of FIG. 1 with the handle extended.

FIG. 3 is a top view of the shaving device of FIG. 1 with the handle retracted and the head detached.

FIGS. 3A-C are transverse cross-sections through the handle of the device of FIG. 2 at proximal, intermediate, and distal locations respectively.

FIG. 4 is a side cross-section of a distal portion of the device of FIG. 1 with the head removed from the handle.

FIG. 5 is a side cross-section of a distal portion of the device of FIG. 1 with the head attached to the handle.

### DETAILED DESCRIPTION OF THE INVENTION

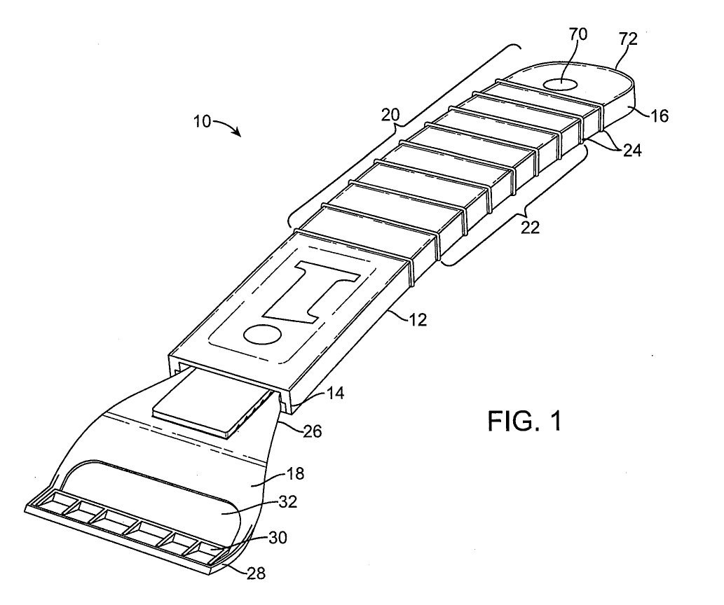

Referring to FIG. 1, in one embodiment a shaving device 10 according to the invention includes an elongated handle 12 having a distal end 14 and a proximal end 16, and a head 18 coupled to the distal end 14 of the handle. A proximal extremity 20 of handle 12 comprises a gripping area 22 adapted to be gripped in the user's hand. Gripping area 22 may include transverse ridges 24 or other surface features or materials to enhance grip. Handle 12 may have a variety of shapes which are selected according to the region of the body to be shaved. In an exemplary embodiment, handle 12 has a curvature about a transverse axis with the concave side of the curvature facing in the working direction, that is, toward the surface of the body to be shaved. Additionally, an aperture 70 is disposed near the proximal handle end 16 to permit the device 10 to be hung from a wall hook or other suitable hanger. In an exemplary embodiment, proximal end 16 is also curved 72 in order to minimize sharp edges and provide a smooth end.

Head 18 has a proximal portion 26 which is preferably detachably coupled to the distal end 14 of handle 12 as described more fully below. Head 18 has a distal portion 28 to which a blade (not shown in FIG. 1) and a blade guard 30 are mounted. Head 18 defines a transverse slot 32 into which a cutting edge of the blade extends in the proximal direction, as described below.

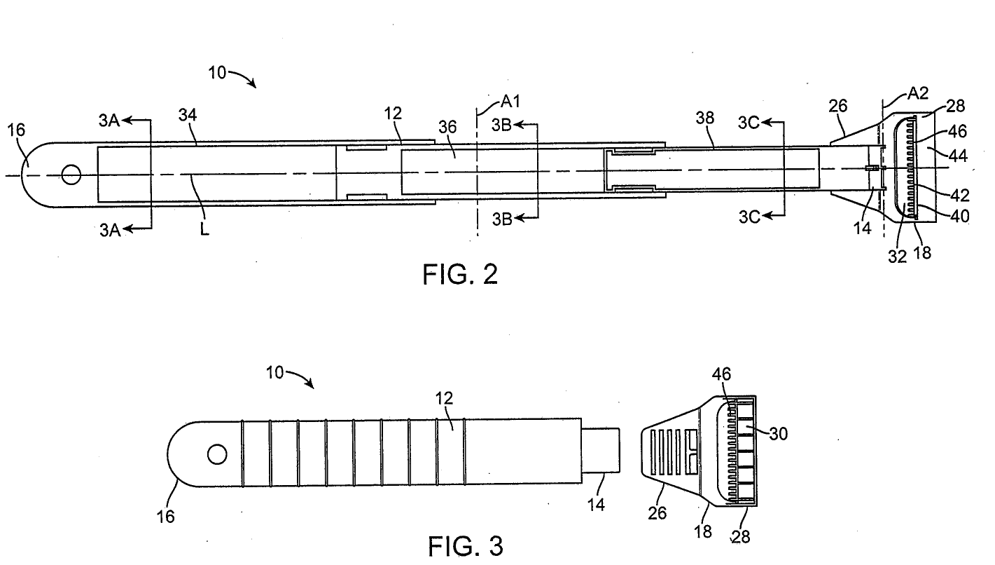

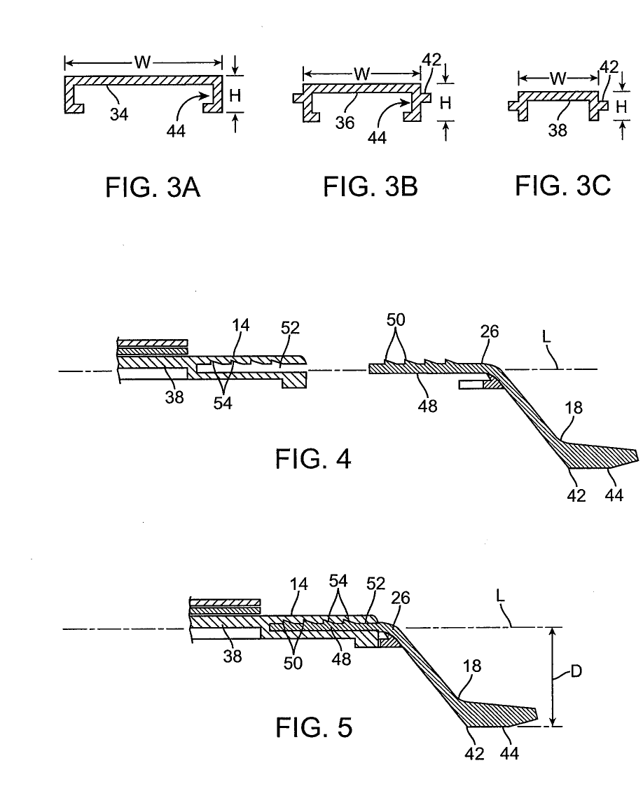

Referring to FIGS. 2 and 3, handle 12 preferably has a telescoping construction so as to be extendable from a retracted length (FIG. 3, shown with head 18 detached from handle 12) to an extended length (FIG. 2 with head 18 attached to handle 12). In a preferred embodiment the handle comprises a proximal member 34, an intermediate member 36 and a distal member 38, all slidably coupled to one another. In exemplary embodiments, the handle is about 5 to 15 inches long in the retracted configuration, and is extendable to at least about 1.5 times, and preferably at least about 2 times the retracted length, to an extended length of about 10 to 40 inches long. Of course the optimal length will depend on the area of the body to be shaved and the size and physical limitations of the user, therefore any length may be employed.

The size, shape, and material selected for the proximal, intermediate, and distal members 34, 36, 38 will provide flexibility and resilience such that handle 12, in the extended configuration, is deflectable about a transverse axis A1 parallel to the edge of the blade 40 and perpendicular to longitudinal axis L of handle 12. In this way, if the user exerts a certain degree of pressure on the handle 12 with the head 18 against the surface to be shaved, handle 12 will flex and head 18 will deflect around axis A1. When pressure is released, head 18 will resiliently return to its original position. At the same time, the members 34, 36, 38 will be substantially rigid and undeflectable laterally about an axis perpendicular to both transverse axis A1 and to the longitudinal axis L.

Cross-sections of the proximal, intermediate, and distal members 34, 36, 38 are taken along lines 3A-3A, 3B-3B and 3C-3C in FIG. 2 and these are illustrated in FIGS. 3A-C. In a preferred embodiment the proximal, intermediate and distal members 34, 36, 38 preferably have a channel-shaped transverse cross-section as shown in FIGS. 3A-C, with the width W of the cross section being at least about 3 times, and preferably at least 5 times, the height H. Intermediate member 36 and distal member 38 each have longitudinal tongues 42 on the lateral edges thereof which are slidably received in the channels 44 of the adjacent member. This allows members 34, 36, 38 to slide relative to one another without binding. The proximal, intermediate, and distal members 34, 36, 38 may be any of a variety of resilient and flexible materials, including plastics and metals. The materials utilized should also provide chemical resistance to shaving creams, lotions soaps and the like, commonly used during shaving in order to minimize the possibility of crazing, cracking, fatiguing or other failure modes affected by chemicals.

To further enhance the deflectability of head 18, in preferred embodiments, head 18 is itself flexible such that the distal portion 28 is resiliently deflectable around a transverse axis A2 relative to proximal portion 26 thereof. Head 28 may be constructed of a thin, flat plastic or metal to provide such flexibility and resilience.

It may be seen in FIG. 2 that blade 40 has a sharp, hair-cutting edge 42 that extends proximally into slot 32. Blade 40 is attached to head 18 by means of screws, rivets or other suitable fasteners, which may be covered by blade guard 30. Distal portion 28 of head 18 has a working surface 44 that is smooth and slippery for engaging the skin adjacent to blade 40. Working surface 44 may be flat or curved or angled upwardly in the distal direction to facilitate sliding the head 18 along the skin surface. As shown in FIG. 3, blade guard 30 has a plurality of teeth 46 extending over the blade on the upper surface thereof (opposite the working surface 44). Teeth 46 are oriented perpendicular to blade edge 42 and extend in the proximal direction beyond the edge 42. In this way, as blade 40 slides across the skin surface to be shaved, hair is channeled in between the teeth 46 to be cut by blade 40. However, if the angle of the blade relative to the skin becomes too steep, teeth 46 engage the skin and prevent blade 40 from cutting the skin. This is particularly advantageous when shaving areas of the body that must be accessed at awkward angles and/or cannot be seen by the user during shaving, such as the back.

Referring now to FIGS. 4 and 5, head 18 is preferably detachably coupled to distal end 14 of handle 12. In an exemplary embodiment, the proximal portion 26 of head 18 has a tongue 48 having a plurality of transverse ridges 50. Distal end 14 of distal member 38 has a receptacle 52 with a plurality of catches or grooves 54 configured to engage with ridges 50, thereby retaining tongue 48 within receptacle 52.

As seen in FIG. 5, the working surface 44, along with blade edge 42 are spaced apart from the longitudinal axis of handle 12 (as defined by a distal portion of the distal member 38) by a distance D, selected to optimize shaving of the desired region of the body. In an exemplary embodiment, distance D is about 0.25 to 2 inches, more preferably about 0.5 to 1 inch. Of course, this offset distance D, as well as the size, shape and angle of blade 40 and working surface 44 may be selected from a range of possibilities according to the area to be shaved and the user's size, physical limitations, and preferences.

While the above is a complete description of the preferred embodiments of the invention, various alternatives, modifications, substitutions and additions are possible without departing from the scope thereof, which is defined by the following claims.

What is claimed is:

1. A shaving device comprising:
a head;
a blade mounted to the head and having an edge adapted for cutting hair;
an elongated handle having a distal end coupled to the head and a proximal extremity adapted for being held in a user's hand, the elongated handle being resiliently deflectable about a transverse axis.

2. The shaving device of claim 1 wherein the handle is extendable from a retracted length to an extended length.

3. The shaving device of claim 1 wherein the extended length of the handle is at least about 8 inches.

4. The shaving device of claim 1 wherein the handle comprises a proximal member and a distal member, the distal member being longitudinally slidable relative to the proximal member.

5. The shaving device of claim 4 wherein the handle comprises an intermediate member coupled between the proximal and distal members, the intermediate member being longitudinally slidable relative to the proximal member and the distal member.

6. The shaving device of claim 4 wherein the distal and proximal members have a rectangular transverse cross-section, the width of the cross-section being at least twice the height.

7. The shaving device of claim 1 wherein the head is detachably coupled to the handle.

8. The shaving device of claim 1 wherein the head is flexible such that the blade is resiliently deflectable about a transverse axis relative to the handle.

9. The shaving device of claim 1 wherein the handle comprises a receptacle at the distal end and the head comprises a tongue removably positionable in the receptacle.

10. The shaving device of claim 9 wherein the receptacle comprises a catch, and the tongue comprises at least one transverse ridge, the catch engaging the ridge to maintain the tongue in the receptacle.

11. The shaving device of claim 1 wherein a distal extremity of the handle defines a longitudinal axis, the edge of the blade being transverse to and spaced apart from the longitudinal axis.

12. The shaving device of claim 1 wherein the head comprises a frame forming a transverse slot into which the edge of the blade extends.

13. The shaving device of claim 12 wherein the frame further comprises a plurality of teeth extending into the slot over the edge of the blade on an upper side thereof.

14. A method of shaving hair from a region of the body comprising:
providing a shaving device having a handle, a head, and a blade attached to the head;
detachably coupling the head to a distal end of the handle;
extending the handle from a retracted length to an extended length;
positioning a working surface of the head against a skin surface in the region of the body;
applying pressure to a proximal end of the handle such that the head deflects about a transverse axis;
manipulating the handle so as to slide the blade across the skin surface in a direction transverse to the blade, thereby cutting the hair.

15. The method of claim 14 wherein the head comprises a plurality of teeth extending over the blade on an upper side thereof opposite the working surface, and wherein the hair is channeled in between the teeth as the blade slides across the skin surface.

16. The method of claim 15 wherein the teeth engage the skin as the blade slides across the skin surface to prevent the blade from cutting the skin.

17. The method of claim 14 wherein the region of the body is the back.
